(19) United States
(12) Patent Application Publication
(10) Pub. No.: US 2021/0002059 A1
(43) Pub. Date: Jan. 7, 2021

(54) PACKAGE FOR USE WITH GRILLING APPARATUS

(71) Applicant: Bemis Company, Inc., Neenah, WI (US)

(72) Inventors: Reinaldo V. Caleman, JR., Neenah, WI (US); Janelle M. Schwach, Menasha, WI (US)

(21) Appl. No.: 16/503,390

(22) Filed: Jul. 3, 2019

(51) Int. Cl. B65D 81/34

(52) U.S. Cl. CPC B65D 81/3407; B32B 27/08; B32B 2250/05

(57) ABSTRACT

A package is described. This package comprises a first wall comprising a first multilayer film comprising a first wall exterior layer comprising metal foil and a first wall interior layer. The first multilayer film is thermally stable after exposure to temperatures greater than about 220° C. (425° F.). The package also comprises a second wall opposing the first wall. The second wall comprises a second multilayer film. The second wall is thermally stable after exposure to temperatures up to about 220° C. (425° F.). The first multilayer film is configured to form a hermetic seal with the second multilayer film. Various embodiments of the package are also described. In some embodiments, the first multilayer film is configured to be placed adjacent the heat source of a grilling apparatus and the second multilayer film is configured to be placed opposite the heat source of a grilling apparatus.

The present application describes a package that may be used with a grilling apparatus. The package comprises a first wall comprising an exterior layer of metal foil and a second wall. Each of the first wall and the second wall is thermally stable after exposure to certain temperatures, and the first wall is thermally stable at temperatures greater than about 220° C. (425° F.). The package provides improved mechanical toughness and abuse resistance and increased end-user convenience compared to known packages.

### BACKGROUND

Current ovenable films allow end-user consumers to cook meat in an oven in the original package. However, such films are regulated as oven-safe or thermally stable up to only about 220° C. (425° F.). As such, ovenable films cannot be considered thermally stable when used with various grilling apparatus, which can reach temperatures greater than about 220° C. (425° F.).

Current commercial grillable packages are limited to packages which the end-user consumer purchases and then fills with a food item to be grilled, causing end-user consumer inconvenience and direct contact with raw meat. Additionally, current commercial grillable packages comprising thermoplastic materials have limited mechanical toughness and abuse resistance. For example, Grilling Bags, a package commercially available from Planit Products Ltd (Malvern, United Kingdom), have a first wall comprising a single layer aluminum foil (“monolayer foil”) and a second wall comprising a single layer oriented polyethylene terephthalate (OPET) (“monolayer OPET”).

U.S. Pat. No. 2,951,765 (Robson) discloses a disposable bag in which food (i.e., fish) may be packaged and later broiled after removal of a detachable section of the bag. Each wall of this bag requires a metal foil in order to protect a thermoplastic film layer. Such bag also requires placing slits one wall and placing an impermeable overwrap around the bag after the bag has been packaged with fish. This patent is silent regarding a package wall not specifically requiring a metal foil and a package that an end-user consumer may use “as is.”

U.S. Pat. No. 10,099,832 (Arning et al.) discloses a bag for storing and preparing food. Each sheet of the bag comprises a composite material including an inside layer of plastic and an outside layer of paper or metal foil. The composite material may be heat resistant up to 220° C. (425° F.) so that it can be used as a roasting bag for cooking food in an oven. This patent is silent regarding use of the bag with various grilling apparatus, which can reach temperatures greater than about 220° C. (425° F.).

### SUMMARY

What is needed is a package that has sufficient mechanical toughness and abuse resistance (e.g., puncture resistance, tear resistance, flex-crack resistance, etc.) to allow for packing, shipping, and distribution of a food product and that is convenient for an end-user consumer to use with a grilling apparatus that can reach temperatures greater than about 220° C. (425° F.). These needs are met by the package described in the present application. This package is thermally stable after exposure to temperatures greater than 220° C. (425° F.) and has sufficient mechanical toughness and abuse resistance.

In a first set of embodiments, the package comprises a first wall and a second wall.

The first wall comprises a first multilayer film comprising a first wall exterior layer comprising metal foil and a first wall interior layer. In some embodiments, the metal foil comprises aluminum foil. The first multilayer film is configured to be placed adjacent the heat source of a grilling apparatus and is thermally stable after exposure to temperatures greater than about 220° C. (425° F.). In some embodiments, the first multilayer film is thermally stable after exposure to temperatures from greater than about 220° C. (425° F.) to about 480° C. (900° F.). In some embodiments, the first multilayer film has a puncture resistance in accordance with ASTM F1306 of greater than about 10 Newtons and a tear resistance in accordance with D1922 in each of the machine direction and transverse direction of greater than about 30 gram-force. In some embodiments, the first wall exterior layer has a thickness of less than about 25 micron (1 mil). In some embodiments, the first wall exterior layer has a thickness of from about 6 micron (0.23 mil) to about 24 micron (0.94 mil).

The second wall opposes the first wall and comprises a second multilayer film comprising a second wall exterior layer and a second wall interior layer. The second multilayer film is configured to be placed opposite the heat source of a grilling apparatus and is thermally stable after exposure to temperatures up to about 220° C. (425° F.). In some embodiments, the second multilayer film has a puncture resistance in accordance with ASTM F1306 of greater than about 30 Newtons and a tear resistance in accordance with D1922 in each of the machine direction and transverse direction of greater than about 15 gram-force. In some embodiments, the second multilayer film comprises a transparent portion.

In the first set of embodiments, the first multilayer film is configured to form a hermetic seal with the second multilayer film.

In some embodiments of the first set of embodiments, the first multilayer film comprises a layer comprising polyamide, a layer comprising polyester, or a layer comprising polyamide and a layer comprising polyester; the second multilayer film comprises a layer comprising polyamide, a layer comprising polyester, or a layer comprising polyamide and a layer comprising polyester; or each of the first multilayer film and the second multilayer film comprises a layer comprising polyamide, a layer comprising polyester, or a layer comprising polyamide and a layer comprising polyester. In some embodiments, the second multilayer film comprises a second wall exterior layer comprising polyamide or polyester.

In some embodiments of the first set of embodiments, the first wall interior layer is a first wall sealant layer comprising polyester, the second wall interior layer is a second wall sealant layer comprising polyester, or the first wall interior layer is a first wall sealant layer comprising polyester and the second wall interior layer is a second wall sealant layer comprising polyester.

In a second set of embodiments, the package comprises a first wall and a second wall.

The first wall comprises a first multilayer film comprising a first wall exterior layer comprising aluminum foil and a first wall interior layer comprising polyester. The first multilayer film is thermally stable after exposure to temperatures greater than about 220° C. (425° F.). In some embodiments, the first multilayer film is thermally stable after exposure to temperatures from greater than about 220° C. (425° F.) to about 480° C. (900° F.). The first wall exterior layer has a thickness of less than about 25 micron (1 mil). In some embodiments, the first wall exterior layer has a thickness of from about 6 micron (0.23 mil) to about 24 micron (0.94 mil).

The second wall opposes the first wall and comprises a second multilayer film comprising a second wall exterior layer comprising polyamide or polyester and a second wall interior layer comprising polyester. The second multilayer film is thermally stable after exposure to temperatures up to about 220° C. (425° F.). In some embodiments, the second multilayer film comprises a transparent portion.

In the second set of embodiments, the first wall interior layer is configured to form a hermetic seal with the second wall interior layer.

In some embodiments of the second set of embodiments, the first multilayer film is configured to be placed adjacent the heat source of a grilling apparatus and the second multilayer film is configured to be placed opposite the heat source of a grilling apparatus.

In a third set of embodiments, the package comprises a first wall, a second wall, a food item, and a hermetic seal.

The first wall comprises a first multilayer film comprising a first wall exterior layer comprising aluminum foil and a first wall interior layer comprising polyester. The first multilayer film is thermally stable after exposure to temperatures from greater than about 220° C. (425° F.) to about 480° C. (900° F.), and the first wall exterior layer has a thickness of from about 6 micron (0.23 mil) to about 24 micron (0.94 mil).

The second wall opposes the first wall and comprises a second multilayer film comprising a second wall exterior layer comprising polyamide or polyester and a second wall interior layer comprising polyester. The second multilayer film is thermally stable after exposure to temperatures up to about 220° C. (425° F.), and the second multilayer film comprises a transparent portion.

The hermetic seal seals the first wall interior layer to the second wall interior layer. In some embodiments, a portion of the hermetic seal sealing the first wall interior layer to the second wall interior layer is configured to vent when the package is exposed to a heat source.

In some embodiments of the third set of embodiments, the first multilayer film is configured to be placed adjacent the heat source of a grilling apparatus and the second multilayer film is configured to be placed opposite the heat source of a grilling apparatus.

In some embodiments of the third set of embodiments, the package is a pouch. In some embodiments, the package is a forming/non-forming package, with the first multilayer film being a non-forming film and the second multilayer film being a forming film.

### BRIEF DESCRIPTION OF THE DRAWINGS

FIG. 1 is a schematic top view of a first general embodiment of a package according to the present application.

FIG. 2 is a schematic cross-sectional view of a first embodiment of the package of FIG. 1, taken along the line 2-2.

FIG. 3 is a schematic cross-sectional view of a second embodiment of the package of FIG. 1, taken along the line 2-2.

FIG. 4 is a schematic top view of a second general embodiment of a package according to the present application.

FIG. 5 is a schematic cross-sectional view of an embodiment of the package of FIG. 4, taken along the line 2-2.

### DETAILED DESCRIPTION

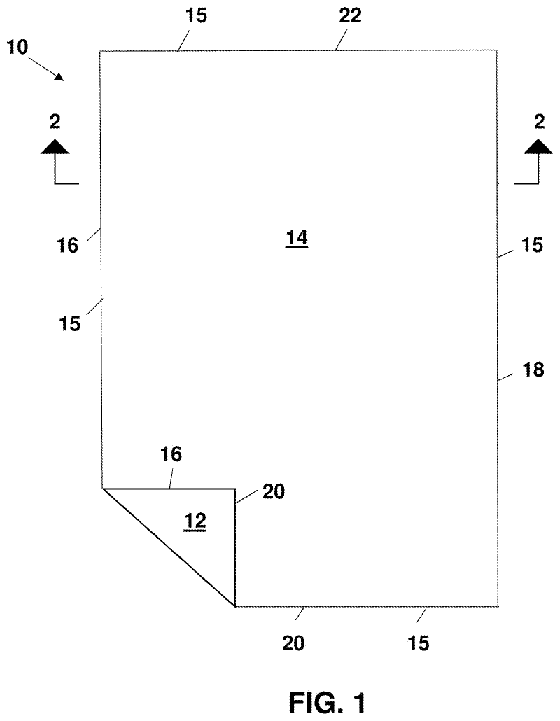

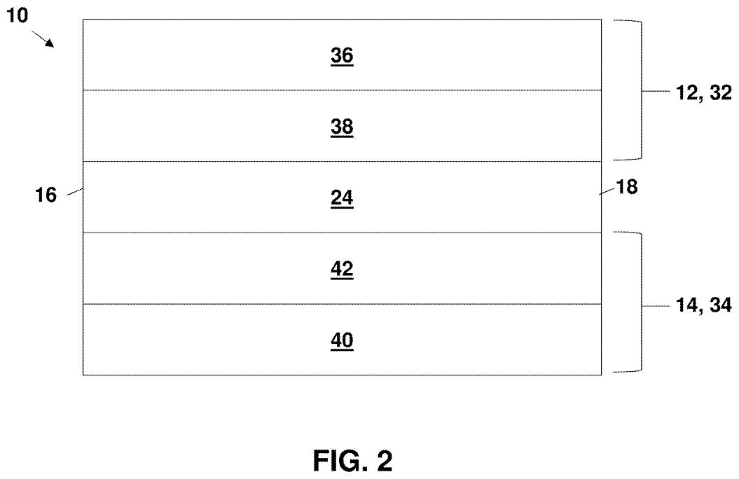

Referring to the drawings, with some but not all embodiments depicted, with elements depicted as illustrative and not necessarily to scale, and with the same (or similar) reference numbers denoting the same (or similar) features throughout the drawings, FIG. 1 is a schematic top view of a first general embodiment of a package according to the present application. FIG. 2 is a schematic cross-sectional view of the package of FIG. 1, taken along the line 2-2. As used throughout this application, the term “package” refers to any article used to wholly or partially surround or contain an item. A package may take many, various forms. For example, the term “package” may include pouches that wholly surround or contain an item (or items) to be packaged. The term “package” may also include films, sheets, etc. that partially surround or contain an item (or items) to be packaged and, when used in conjunction with another film, sheet, etc. wholly surround or contain an item (or items). As non-limiting examples, the term “package” includes pouches, bags, trays, cups, lidding materials, plates, bulk container liners, or other items.

As depicted in FIG. 1, package 10 is a package with an up-turned corner. Package 10 comprises first wall 12 and second wall 14 opposing first wall 12. FIG. 1 depicts first wall 12 facing in and second wall 14 facing out. Package 10 further comprises perimeter 15 comprising first edge 16, second edge 18 opposing first edge 16, third edge 20 substantially perpendicular to first edge 16 and second edge 18, and fourth edge 22 opposing third edge 20. (As used throughout this application, the term “substantially” refers to being for the most part, primarily, principally, predominantly, chiefly, mainly, mostly, or generally. A property that is “substantially” may not be completely, fully, perfectly, thoroughly, totally, or wholly. For example, for package 10 in FIG. 1, the angle at which third edge 20 intersects first edge 16 or second edge 18 may be equal to 90 degrees or may be slightly less than or slightly greater than 90 degrees.) As depicted in FIG. 1, when sealed, package 10 with first wall 12, second wall 14, and perimeter 15 is configured to fully enclose product space 24 (see, e.g., FIG. 2).

In some embodiments, perimeter 15 may be other than four-sided (e.g., three-sided, five-sided, six-sided, etc.), and the intersection of first edge 16, third edge 20, second edge 18, and fourth edge 22 may not be at distinct corners. In such embodiments, first edge 16, second edge 18. third edge 20, and fourth edge 22 may have relative positions, but not necessarily exact positions, as described in the present application.

As depicted in FIG. 2, first wall 12 comprises first multilayer film 32 and second wall 14 comprises second multilayer film 34. As used throughout this application, the term “film” refers to a web having any thickness and comprising thermoplastic materials and is not limited to a web having a thickness of less than about 250 micron (10 mil). The term “sheet” refers to a web having any thickness and comprising thermoplastic materials and is not limited to a web having a thickness of greater than about 250 micron (10 mil). As used throughout this application, the term “thermoplastic” refers to a polymer or polymer mixture that softens after exposure to heat and then returns to its original condition when cooled to room temperature. As used throughout this application, the term “multilayer” refers to a film comprising more than one layer, as contrasted with “monolayer,” which refers to a film comprising one single layer The multilayer films described in the present application may have 2, 3, 4, 5, 6, 7, 8, 9, 10, 11, 12, 13, 14, 15, 16, 17, 18, 19, 20, or more layers and are not limited to two layers.

As depicted in FIG. 2, first multilayer film 32 comprises two layers, first wall exterior layer 36 and first wall interior layer 38, and second multilayer film 34 comprises two layers, second wall exterior layer 40 and second wall interior layer 42. As used throughout this application, the term “exterior layer” refers to a layer comprising the outermost surface of a film, sheet, web, package, or other article, e.g., the layer to be most distant from package contents. The term “interior layer” refers to a layer comprising the innermost surface of a film, sheet, web, package, or other article, e.g., the layer to be most adjacent to package contents. Additionally, the exterior layer and the interior layer each have an inner surface and an outer surface. The term “inner surface” refers to a surface touching another layer, and the term “outer surface” refers to a surface not touching another layer. Correspondingly, the term “inner layer” refers to a layer having an inner surface on each surface and is distinct from an interior layer.

First wall exterior layer 36 comprises metal foil. As used throughout this application, the term “metal foil” refers to a sheet of malleable or ductile metal, including but not limited to aluminum, copper, tin, or gold. In some embodiments, first wall exterior layer 36 comprises metal foil comprising aluminum foil. In some embodiments, first wall exterior layer 36 may have a thickness of less than about 25 micron (1 mil) or from about 6 micron (0.23 mil) to about 24 micron (0.94 mil) or from about 6 micron (0.23 mil) to about 18 micron (0.70 mil) or from about 8 micron (0.31 mil) to about 18 micron (0.70 mil) or from about 8 micron (0.31 mil) to about 12 micron (0.47 mil) of from about 8 micron (0.31 mil) to about 10 micron (0.39 mil) or about 9 micron (0.35 mil). In some embodiments, metal foil may serve to deflect heat when first multilayer film 32 is exposed to a heat source, such as the heat source of a grilling apparatus.

First multilayer film 32 is configured to be placed adjacent the heat source of a grilling apparatus. As used throughout this application, the term “adjacent” refers to being near, close, contiguous, adjoining, or neighboring in proximity. It includes but is not limited to being reasonably close to, in the vicinity of, directly above, or next to as well as touching, having a common boundary, or having direct contact. In contrast, second multilayer film 34 of second wall 14 opposing first wall 12 is configured to be placed opposite (relative to first multilayer film 32) the heat source of a grilling apparatus. As such, first multilayer film 32 is configured to be placed closer to the heat source of a grilling apparatus than second multilayer film 34.

As used throughout this application, the term “grilling apparatus” includes various kinds of grilling apparatus and methods, including but not limited to gridironing (e.g., in which a rack (e.g., series of parallel bars) is placed directly or indirectly above a heat source), charcoal kettle-grilling or grill-braising (e.g., in which a kettle or other pot is placed directly or indirectly in or above a heat source), grill-baking (e.g., in which a cooking pan or sheet is placed directly or indirectly above a heat source), plank grilling (e.g., in which a piece of wood is placed directly or indirectly in or above a heat source), stove-top pan grilling (e.g., in which a grill pan is placed on a stove top), flattop grilling (e.g., in which a griddle or flat pan is placed directly or indirectly in or above a heat source), overhead grilling (e.g., in which an oven pan is placed in a broiler), sear grilling (e.g., in which a ceramic plate is placed in an infrared grill), or other apparatus and methods known to a person of ordinary skill in the grilling arts.

First multilayer film 32 is thermally stable after exposure to temperatures greater than about 220° C. (425° F.). As used throughout this application, the term “thermally stable after exposure to temperatures” of a certain degree refers to an article capable of maintaining dimensionality and shape and not substantially distorting or deforming after exposure to temperatures of that certain degree. Temperatures of a certain degree include but are not limited to temperatures of materials placed in or on the package or temperatures in the environment surrounding the package (e.g., direct heat from the heat source of a grilling apparatus or indirect heat from the heat source of a grilling apparatus) or the temperatures experienced by the rising temperature of a material placed in or on the package as a filled package is heated by a grilling apparatus. For example, first multilayer film 32 maintains dimensionality and shape and does not substantially distort or deform after exposure to temperatures greater than about 220° C. (425° F.). In some embodiments, first multilayer film 32 is thermally stable after exposure to temperatures greater than about 232° C. (450° F.), greater than about 260° C. (500° F.), from greater than about 220° C. (425° F.) to about 480° C. (900° F.), from greater than about 220° C. (425° F.) to about 370° C. (700° F.), from about 232° C. (450° F.) to about 480° C. (900° F.), from about 232° C. (450° F.) to about 370° C. (700° F.), from about 232° C. (450° F.) to about 343° C. (650° F.), from about 232° C. (450° F.) to about 260° C. (500° F.), or from about 288° C. (550° F.) to about 370° C. (700° F.).

When first multilayer film 32 of first wall 12 of package 10 is, as a non-limiting example, placed directly above the heat source of a gridiron grilling apparatus, first multilayer film 32 may be exposed to temperatures of from about 232° C. (450° F.) to about 370° C. (700° F.). As a non-limiting example, on such grilling apparatus, burgers and steaks may be cooked at a grilling apparatus temperature of from about 288° C. (550° F.) to about 370° C. (700° F.) and chicken and vegetables may be cooked at a grilling apparatus temperature of from about 232° C. (450° F.) to about 260° C. (500° F.). As a further non-limiting example, when first multilayer film 32 of first wall 12 of package 10 is placed on a ceramic plate in an infrared grill for sear grilling, first multilayer film 32 may be exposed to temperatures of from about 232° C. (450° F.) to 480° C. (900° F.) or greater.

Second multilayer film 34 is thermally stable after exposure to temperatures up to about 220° C. (425° F.). For example, second multilayer film 34 maintains dimensionality and shape and does not substantially distort or deform after exposure to temperatures up to about 220° C. (425° F.). In some embodiments, second multilayer film 34 is thermally stable after exposure to temperatures from about 93° C. (200° F.) to about 220° C. (425° F.), from about 121° C. (250° F.) to about 220° C. (425° F.), from about 149° C. (300° F.) to about 220° C. (425° F.), from about 149° C. (300° F.) to about 204° C. (400° F.), or from about 177° C. (350° F.) to about 204° C. (400° F.).

First multilayer film 32 of first wall 12 is configured to form a hermetic seal with second multilayer film 34 of second wall 14. As used throughout this application, the term “hermetic seal” refers to a portion of first multilayer film 32 which is capable of forming a fusion bond to a portion of second multilayer film 34, such that the bond is complete and continuous so that no air or other gas enters package 10 at the fusion bond. Such hermetic seal may be formed by conventional heating means which generate sufficient heat on at least one of first multilayer film 32 or second multilayer film 34 for conduction to the other. Such heating may be performed by any one or more of a wide variety of methods, including but not limited to melt-bead sealing, thermal sealing, hot air sealing, hot wire sealing, infrared radiation, etc. A hermetic seal may also be formed by impulse sealing, ultrasonic sealing, pressure sealing, or other sealing methods known to a person of ordinary skill in the packaging arts.

In some embodiments of package 10 of FIG. 2, first multilayer film 32 may comprise a layer comprising polyamide, a layer comprising polyester, or a layer comprising polyamide and a layer comprising polyester, second multilayer film 34 may comprise a layer comprising polyamide, a layer comprising polyester, or a layer comprising polyamide and a layer comprising polyester, or each of first multilayer film 32 and second multilayer film 34 may comprise a layer comprising polyamide, a layer comprising polyester, or a layer comprising polyamide and a layer comprising polyester. The addition of a layer comprising polyamide, a layer comprising polyester, or a layer comprising polyamide and a layer comprising polyester to either first wall multilayer film 32 or second multilayer film 34 or both first wall multilayer film 32 and second multilayer film 34 along with metal foil in first wall exterior layer 36 of first multilayer film 32 may contribute to increased mechanical toughness and abuse resistance (e.g., puncture resistance, tear resistance, flex-crack resistance, etc.) of package 10 and to the ability of package 10 to, for example, withstand packing, shipping, and distribution of a food product.

As a non-limiting example, in some embodiments, second wall exterior layer 40 of second multilayer film 34 may comprise polyamide. In other embodiments, second wall exterior layer 40 of second multilayer film 34 may comprise polyester. In yet other embodiments, each of first multilayer film 32 and second multilayer film 34 may comprise two inner layers of polyamide.

As used throughout this application, the term “polyamide” or “PA” or “nylon” refers to a homopolymer or copolymer having recurring amide linkages. The amide linkage may be represented by the general formula: [C(O)—R—C(O)—NH—R′—NH]ₙ where R and R′ are the same or different alkyl (or aryl) group. Polyamides may be formed by any method known in the art. Recurring amide linkages may be formed by the reaction of one or more diamines and one or more diacids. Non-limiting examples of suitable diamines include 1,4-diamino butane, hexamethylene diamine, decamethylene diamine, metaxylylene diamine, and isophorone diamine. Non-limiting examples of suitable diacids include terephthalic acid, isophthalic acid, 2,5-furandicarboxylic acid, succinic acid, adipic acid, azelaic acid, capric acid, and lauric acid. Polyamides may also be formed by the ring-opening polymerization of suitable cyclic lactams like ε-caprolactam, ω-undecanolactam, and ω-dodecalactam. Polyamides may be high-temperature, low-temperature, or amorphous, as described in, for example, International Publication Number WO 2006/063283. Examples of polyamide polymers include but are not limited to nylon 6 (polycaprolactam), nylon 11 (polyundecanolactam), nylon 12 (polydodecalactam), nylon 4,2 (polytetramethylene ethylenediamide), nylon 4,6 (polytetramethylene adipamide), nylon 6,6 (polyhexamethylene adipamide), nylon 6,9 (polyhexamethylene azelamide), nylon 6,10 (polyhexamethylene sebacamide), nylon 6,12 (polyhexamethylene dodecanediamide), nylon 7,7 (polyheptamethylene pimelamide), nylon 8,8 (polyoctamethylene suberamide), nylon 9,9 (polynonamethylene azelamide), nylon 10,9 (polydecamethylene azelamide), and nylon 12,12 (polydodecamethylene dodecanediamide). Examples of polyamide copolymers include but are not limited to nylon 6,6/6 copolymer (polyhexamethylene adipamide/caprolactam copolymer), nylon 6,6/9 copolymer (polyhexamethylene adipamide/azelamide copolymer), nylon 6/6,6 copolymer (polycaprolactam/hexamethylene adipamide copolymer), nylon 6,2/6,2 copolymer (polyhexamethylene ethylenediamide/hexamethylene ethylenediamide copolymer), and nylon 6,6/6,9/6 copolymer (polyhexamethylene adipamide/hexamethylene azelamide/caprolactam copolymer). Examples of aromatic polyamide polymers (also sometimes referred to as “amorphous polyamide” or “amorphous nylon”) include but are not limited to nylon 4,I, nylon 6,I, nylon 6,6/6I copolymer, nylon 6,6/6T copolymer, nylon MXD6 (poly-m-xylylene adipamide), poly-p-xylylene adipamide, nylon 6I/6T copolymer (polyhexamethylene terephthalamide/hexamethylene isophthalamide copolymer), nylon 6T/6I copolymer, nylon MXDI, nylon 6/MXDT/I copolymer, nylon 6T (polyhexamethylene terephthalamide), nylon 12T (polydodecamethylene terephthalamide), nylon 66T, and nylon 6-3-T (poly(trimethyl hexamethylene terephthalamide). In some embodiments, a polyamide layer or polyamide layers may comprise a blend of polyamides. A further non-limiting example of polyamide is biaxially oriented nylon film. As used throughout this application, the term “biaxially oriented nylon film” or “biaxially oriented polyamide film” or “BON film” or “OPA film” or “BOPA film” refers to a thermoplastic web comprising biaxially oriented nylon.

As used throughout this application, the term “polyester” refers to a homopolymer or copolymer having an ester linkage between monomer units. The ester linkage may be represented by the general formula [O—R—OC(O)—R′—C(O)]ₙ where R and R′ are the same or different alkyl (or aryl) group and may generally be formed from the polymerization of dicarboxylic acid and diol monomers. The dicarboxylic acid (including carboxylic acid moieties) may be linear or aliphatic (e.g., oxalic acid, maleic acid, succinic acid, glutaric acid, adipic acid, pimelic acid, suberic acid, azelaic acid, sebacic acid, and the like) or may be aromatic or alkyl substituted aromatic (e.g., various isomers of phthalic acid, such as paraphthalic acid (or terephthalic acid), isophthalic acid, and naphthalic acid). Specific examples of a useful diol include but are not limited to ethylene glycol, propylene glycol, trimethylene glycol, 1,4-butane diol, neopentyl glycol, cyclohexane dial, 2,2,4,4-tetramethyl-1,3-cyclobutanediol, or the like. Polyesters may include a homopolymer or a copolymer of alkyl-aromatic esters, including but not limited to polyethylene terephthalate (PET), oriented polyethylene terephthalate (OPET), amorphous polyethylene terephthalate (APET), glycol-modified polyethylene terephthalate (PETG), and polybutylene terephthalate (PBT); a copolymer of terephthalate and isophthalate including but not limited to polyethylene terephthalate/isophthalate copolymer, such as isophthalic acid (IPA) (modified polyethylene terephthalate (PETI)); a homopolymer or copolymer of aliphatic esters including but not limited to polylactic acid (PLA); polyhydroxyalkonates including but not limited to polyhydroxypropionate, poly(3-hydroxybutyrate) (PH3B), poly(3-hydroxyvalerate) (PH3V), poly(4-hydroxybutyrate) (PH4B), poly(4-hydroxyvalerate) (PH4V), poly(5-hydroxyvalerate) (PH5V), poly(6-hydroxydodecanoate) (PH6D); or blends of any of these materials. A further non-limiting example of polyester is biaxially oriented polyethylene terephthalate film. As used throughout this application, the term “biaxially oriented polyethylene terephthalate film” or “biaxially oriented polyester” or “OPET film” or “BOPET film” refers to a thermoplastic web comprising biaxially oriented polyethylene terephthalate.

In some embodiments of package 10 of FIG. 2, first wall interior layer 38 may be a first wall sealant layer comprising polyester, second wall interior layer 42 may be a second wall sealant layer comprising polyester, or each first wall interior layer 38 may be a first wall sealant layer comprising polyester and second wall interior layer 42 may be a second wall sealant layer comprising polyester. As used throughout this application, the term “sealant layer” refers to the specific layer of each of the first multilayer film and the second multilayer film involved in the sealing of the first multilayer film to the second multilayer film. As such, a sealant layer is the interior layer of each of the first multilayer film and the second multilayer film.

As non-limiting examples, a sealant layer comprising polyester may comprise APET, PETG, or OPET. In some embodiments, the OPET may be coated partially or entirely with a heat seal coating to better facilitate sealing. In such embodiments, while the heat seal coating contributes to the sealing of the first multilayer film to the second multilayer film, such heat-sealed coated OPET is considered a polyester-comprising sealant.

In some embodiments of package 10 of FIG. 2, to provide additional oxygen barrier, first multilayer film 32 may comprise a layer comprising ethylene vinyl alcohol copolymer (EVOH), second multilayer film 34 may comprise a layer comprising EVOH, or each of first multilayer film 32 and second multilayer film 34 may comprise a layer comprising EVOH. As used throughout this application, the term “ethylene vinyl alcohol copolymer” or “EVOH” refers to copolymers comprised of repeating units of ethylene and vinyl alcohol. Ethylene vinyl alcohol copolymers may be represented by the general formula: [(CH₂—CH₂)ₙ—(CH₂—CH(OH))]ₙ. Ethylene vinyl alcohol copolymers may include saponified or hydrolyzed ethylene vinyl acetate copolymers. EVOH refers to a vinyl alcohol copolymer having an ethylene co-monomer and prepared by, for example, hydrolysis of vinyl acetate copolymers or by chemical reactions with vinyl alcohol. Ethylene vinyl alcohol copolymers may comprise from 28 mole percent (or less) to 48 mole percent (or greater) ethylene.

In some embodiments of package 10 of FIG. 2, second multilayer film 34 may comprise a transparent portion, such that the package contents in product space 24 are visible and may be viewed through second multilayer film 34. Such transparent portion may be the entirety of second multilayer film 34, such that all of second multilayer film 34 is transparent. In other embodiments, such transparent portion may be a portion of second multilayer film 34, such that one portion (e.g., the portion adjacent the package contents) of second multilayer film 34 is transparent and another portion (e.g., the portion distant from the package contents) of second multilayer film 34 is opaque. In such embodiments, such transparent portion may be formed as a “window” in second multilayer film 34 through which to view the package contents in product space 24.

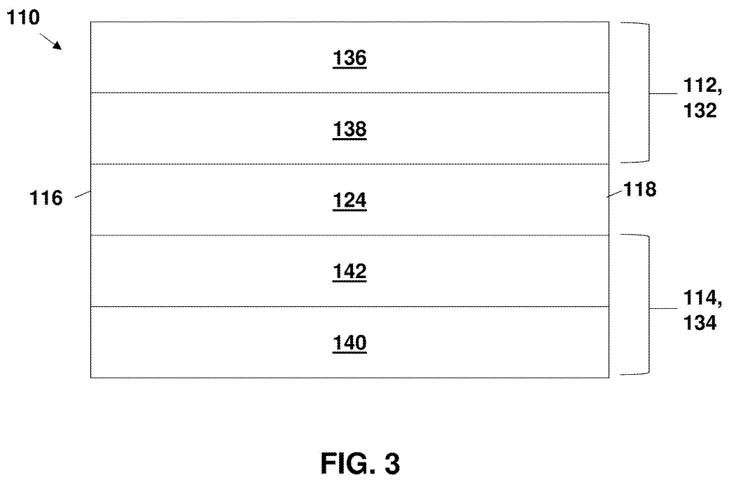

FIG. 3 is a schematic cross-sectional view of a second embodiment of the package of FIG. 1, taken along the line 2-2. Package 110 comprises first wall 112 and second wall 114 opposing first wall 112. Package 110 further comprises first edge 116 and second edge 118 opposing first edge 116. When sealed, package 110 with first wall 112, second wall 114, and a perimeter including first edge 116 and second edge 118 is configured to fully enclose product space 124.

As depicted in FIG. 3, first wall 112 comprises first multilayer film 132. First multilayer film 132 comprises two layers, first wall exterior layer 136 and first wall interior layer 138. In the embodiment of FIG. 3, first wall exterior layer 136 comprises aluminum foil, as described above. First wall interior layer 138 is also a first wall sealant layer and comprises polyester, as described above.

First multilayer film 132 is thermally stable after exposure to temperatures greater than about 220° C. (425° F.). Similar to first multilayer film 32, first multilayer film 132 maintains dimensionality and shape and does not substantially distort or deform after exposure to temperatures greater than about 220° C. (425° F.), as described above. In some embodiments, first multilayer film 132 is thermally stable after exposure to temperatures greater than about 232° C. (450° F.), greater than about 260° C. (500° F.), from greater than about 220° C. (425° F.) to about 480° C. (900° F.), from greater than about 220° C. (425° F.) to about 370° C. (700° F.), from about 232° C. (450° F.) to about 480° C. (900° F.), from about 232° C. (450° F.) to about 370° C. (700° F.), from about 232° C. (450° F.) to about 343° C. (650° F.), from about 232° C. (450° F.) to about 260° C. (500° F.), or from about 288° C. (550° F.) to about 370° C. (700° F.).

First wall exterior layer 136 has a thickness of less than about 25 micron (1 mil). In some embodiments, first wall exterior layer 136 has a thickness of from about 6 micron (0.23 mil) to about 24 micron (0.94 mil) or from about 6 micron (0.23 mil) to about 18 micron (0.70 mil) or from about 8 micron (0.31 mil) to about 18 micron (0.70 mil) or from about 8 micron (0.31 mil) to about 12 micron (0.47 mil) of from about 8 micron (0.31 mil) to about 10 micron (0.39 mil) or about 9 micron (0.35 mil).

As depicted in FIG. 3, second wall 114 comprises second multilayer film 134. Second multilayer film 134 comprises two layers, second wall exterior layer 140 and second wall interior layer 142. Second wall exterior layer 140 comprises polyamide or polyester, as each is described above. Second wall interior layer 142 is also a second wall sealant layer and comprises polyester, as described above.

Second multilayer film 134 is thermally stable after exposure to temperatures up to about 220° C. (425° F.). Similar to second multilayer film 34, second multilayer film 134 maintains dimensionality and shape and does not substantially distort or deform after exposure to temperatures up to about 220° C. (425° F.), as described above. In some embodiments, second multilayer film 134 is thermally stable after exposure to temperatures from about 93° C. (200° F.) to about 220° C. (425° F.), from about 121° C. (250° F.) to about 220° C. (425° F.), from about 149° C. (300° F.) to about 220° C. (425° F.), from about 149° C. (300° F.) to about 204° C. (400° F.), or from about 177° C. (350° F.) to about 204° C. (400° F.).

First wall interior layer 138 as first wall sealant layer is configured to form a hermetic seal with second wall interior layer 142 as second wall sealant layer. This hermetic seal is, and may be formed, as described above.

Similar to first multilayer film 32 and second multilayer film 34, first multilayer film 132 and second multilayer film 134 are not limited to two layers and may comprise any number of layers greater than one, as described above.

In some embodiments of package 110 of FIG. 3 (similar to package 10 described above), first multilayer film 132 is configured to be placed adjacent, as described above, the heat source of a grilling apparatus, as described above. And in such embodiments of package 110, second multilayer film 134 is configured to be placed opposite (relative to first multilayer film 132) the heat source of a grilling apparatus. As with first multilayer film 32 and second multilayer film 34, in some embodiments, first multilayer film 132 is configured to be placed closer to the heat source of a grilling apparatus than second multilayer film 134.

In some embodiments of package 110 of FIG. 3, second multilayer film 134 may comprise a transparent portion, such that the package contents in product space 124 are visible and may be viewed through second multilayer film 134. Such transparent portion may be the entirety of second multilayer film 134, such that all of second multilayer film 134 is transparent. In other embodiments, such transparent portion may be a portion of second multilayer film 134, such that one portion (e.g., the portion adjacent the package contents) of second multilayer film 134 is transparent and another portion (e.g., the portion distant from the package contents) of second multilayer film 134 is opaque. In such embodiments, such transparent portion may be formed as a “window” in second multilayer film 134 through which to view the package contents in product space 124.

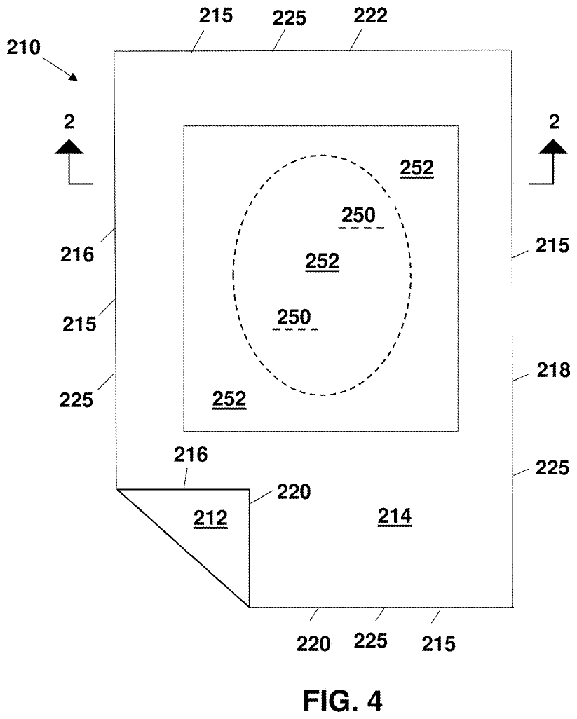

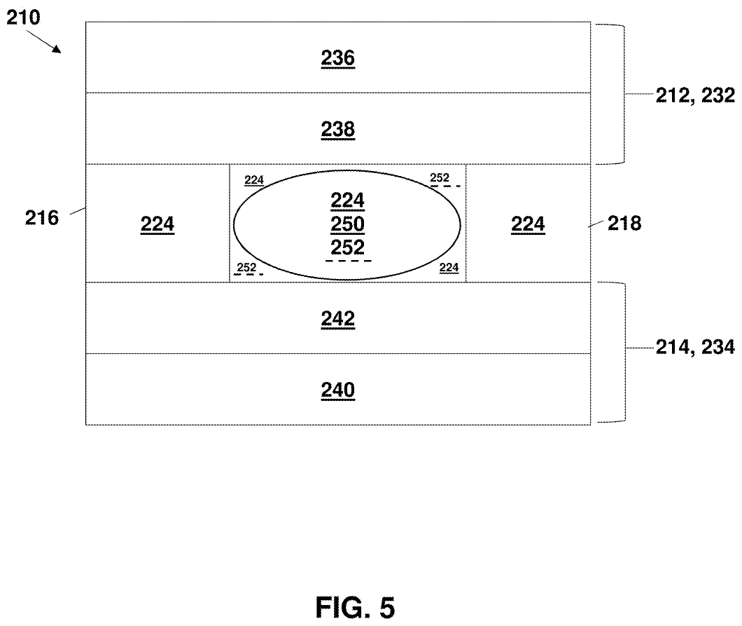

FIG. 4 is a schematic top view of a second general embodiment of a package according to the present application. FIG. 5 is a schematic cross-sectional view of an embodiment of the package of FIG. 4, taken along the line 2-2. As depicted in FIG. 4, package 210 is a sealed package with an up-turned corner. Package 210 comprises first wall 212 and second wall 214 opposing first wall 212. FIG. 4 depicts first wall 212 facing in and second wall 214 facing out. Package 210 further comprises sealed perimeter 215 comprising sealed first edge 216, sealed second edge 218 opposing sealed first edge 216, sealed third edge 220 substantially perpendicular to sealed first edge 216 and sealed second edge 218, and sealed fourth edge 222 opposing sealed third edge 20. Sealed perimeter 215 is equivalent to hermetic seal 225 hermetically sealing first wall 212 (i.e., first wall interior layer 238, as described below) to second wall 214 (i.e., second wall interior layer 242, as described below). Hermetic seal 225 is, and may be formed, as described above. As depicted in FIG. 4, package 210 with first wall 212, second wall 214, and sealed perimeter 215/hermetic seal 225 fully encloses product space 224 (see, e.g., FIG. 5) containing food item 250. Food item 250 may be any food item appropriate to cook or otherwise heat via the heat source of a grilling apparatus, as described above, including but not limited to burgers, steaks, chicken, vegetables, etc.

Package 210 with food item 250 eliminates preparation time and cooking mess and provides increased convenience for an end-user consumer. An end-user consumer may acquire package 210 and place package 210 on a grilling apparatus, without having to contact food item 250, which, in some embodiments, may be a raw meat item. As package 210 is exposed to the heat source of a grilling apparatus, food item 250 is cooked, as appropriate. Cooking seasonings and juices remain in package 210 (and do not drip on the grilling apparatus), resulting in a tender, cooked food item. Cooking mess is contained to package 210, keeping the grilling apparatus cleaner. After use, an end-user consumer may simply discard package 210 for easy clean-up.

As depicted in FIG. 5, first wall 212 comprises first multilayer film 232. First multilayer film 232 comprises two layers, first wall exterior layer 236 and first wall interior layer 238. In the embodiment of FIG. 5, first wall exterior layer 236 comprises aluminum foil, as described above. First wall interior layer 238 is also a first wall sealant layer and comprises polyester, as described above.

First multilayer film 232 is thermally stable after exposure to temperatures from greater than about 220° C. (425° F.) to about 480° C. (900° F.). First multilayer film 232 maintains dimensionality and shape and does not substantially distort or deform after exposure to temperatures from greater than about 220° C. (425° F.) to about 480° C. (900° F.), as described above. In some embodiments, first multilayer film 232 is thermally stable after exposure to temperatures from greater than about 220° C. (425° F.) to about 370° C. (700° F.), from about 232° C. (450° F.) to about 480° C. (900° F.), from about 232° C. (450° F.) to about 370° C. (700° F.), from about 232° C. (450° F.) to about 343° C. (650° F.), from about 232° C. (450° F.) to about 260° C. (500° F.), or from about 288° C. (550° F.) to about 370° C. (700° F.).

First wall exterior layer 236 has a thickness of from about 6 micron (0.23 mil) to about 24 micron (0.94 mil). In some embodiments, first exterior layer 236 has a thickness of from about 6 micron (0.23 mil) to about 18 micron (0.70 mil) or from about 8 micron (0.31 mil) to about 18 micron (0.70 mil) or from about 8 micron (0.31 mil) to about 12 micron (0.47 mil) of from about 8 micron (0.31 mil) to about 10 micron (0.39 mil) or about 9 micron (0.35 mil).

As depicted in FIG. 5, second wall 214 comprises second multilayer film 234. Second multilayer film 234 comprises two layers, second wall exterior layer 240 and second wall interior layer 242. Second wall exterior layer 240 comprises polyamide or polyester, as each is described above. Second wall interior layer 242 is also a second wall sealant layer and comprises polyester, as described above.

Second multilayer film 234 is thermally stable after exposure to temperatures up to about 220° C. (425° F.). Similar to second multilayer film 34 and second multilayer film 134, second multilayer film 234 maintains dimensionality and shape and does not substantially distort or deform after exposure to temperatures up to about 220° C. (425° F.), as described above. In some embodiments, second multilayer film 234 is thermally stable after exposure to temperatures from about 93° C. (200° F.) to about 220° C. (425° F.), from about 121° C. (250° F.) to about 220° C. (425° F.), from about 149° C. (300° F.) to about 220° C. (425° F.), from about 149° C. (300° F.) to about 204° C. (400° F.), or from about 177° C. (350° F.) to about 204° C. (400° F.).

As depicted in FIGS. 4 and 5, second multilayer film 234 comprises transparent portion 252, such that food item 250 in product space 224 is visible and may be viewed through second multilayer film 234. As depicted in FIG. 4, transparent portion 252 is one portion (e.g., the portion adjacent food item 250) of second multilayer film 234, and other portions (e.g., the portion distant from food item 250) of second multilayer film 234 are opaque. As such, transparent portion 252 is formed as a “window” in second multilayer film 234 through which to view food item 250 in product space 224. In other embodiments, the transparent portion may be the entirety of the second multilayer film such that all the second multilayer film is transparent.

Similar to the multilayer films described above, first multilayer film 232 and second multilayer film 234 are not limited to two layers and may comprise any number of layers greater than one, as described above.

In some embodiments of package 210 of FIG. 5 (similar to package 10 and package 110 described above), first multilayer film 232 is configured to be placed adjacent, as described above, the heat source of a grilling apparatus, as described above. And in such embodiments of package 210, second multilayer film 234 is configured to be placed opposite (relative to first multilayer film 232) the heat source of a grilling apparatus. As with first multilayer film 32 and second multilayer film 34 and with first multilayer film 132 and second multilayer film 134, in some embodiments, first multilayer film 232 is configured to be placed closer to the heat source of a grilling apparatus than second multilayer film 234.

In some embodiments of package 210 of FIG. 5, a portion of hermetic seal 225 sealing first wall interior layer 238 to second wall interior layer 242 is configured to vent when package 210 is exposed to a heat source, such as the heat source of a grilling apparatus. In such embodiments, hermetic seal 225 may be configured to self-vent when package 10 is heated. Specific non-limiting examples of self-venting means include but are not limited to lacquer, coating, or other “contamination” in first wall interior layer 238, second wall interior layer 242, or both first wall interior layer 238 and second wall interior layer 242; a release lacquer layer in first multilayer film 232, second multilayer film 234, or both first multilayer film 232 and second multilayer film 234; a micro-perforated or otherwise scored layer in first multilayer film 232, second multilayer film 234, or both first multilayer film 232 and second multilayer film 234; or other self-venting means known to a person of ordinary skill in the packaging arts. Hermetic seal 225 may also be configured to vent upon heating due to action by an end-user, i.e., end-user venting means. Specific non-limiting examples of end-user venting means include but are not limited to an end-user partially opening package 210 at hermetic seal 225; an end-user mechanical creating a score, hole, slit, slot, perforation, notch, puncture, orifice, opening, inlet, channel, etc. in first multilayer film 232, second multilayer film 234, or both first multilayer film 232 and second multilayer film 234; or other end-user venting means known to a person of ordinary skill in the packaging arts.

In addition to the layers described above, the first multilayer film and the second multilayer film of the package described in the present application may each comprise additional layers. Such additional layers may comprise oxygen barrier material, moisture barrier material, chemical barrier material, abuse material, tie material, bulk material, odor scavenger, oxygen scavenger, printing or ink, heat stable material, processing aids, or other materials known to a person of ordinary skill in the packaging arts.

As used through this application, the term or “tie material” or “tie” refers to a polymeric material serving a primary purpose or function of adhering two surfaces to one another, such as the planar surfaces of two film layers. For example, a tie material adheres one film layer surface to another film layer surface or one area of a film layer surface to another area of a film layer surface. Tie material may comprise any polymer, homopolymer, copolymer, or blend of polymers having a polar group or any other polymer, homopolymer, copolymer, or blend of polymers, including modified and unmodified polymers (such as grafted copolymers) which provide sufficient interlayer adhesion to directly adjacent layers comprising otherwise non-adhering polymers. In various embodiments of the present application, tie material may include a single tie material, blends of tie materials, or a blend of tie material with polyethylene, including but not limited to linear low density polyethylene (LLDPE).

As used throughout this application, the term “bulk material” refers to a material adding thickness to a film. In some embodiments, a bulk layer may comprise polyethylene.

As used throughout this application, the term “polyethylene” or “PE”—in reference to the additional layers included in the first multilayer film, the second multilayer film or otherwise—refers (unless indicated otherwise) to ethylene homopolymers or copolymers. Such copolymers of ethylene include copolymers of ethylene with at least one alpha-olefin and copolymers of ethylene with other units or groups such as vinyl acetate, acid groups, acrylate groups, or otherwise. The term “polyethylene” or “PE” is used without regard to the presence or absence of substituent branch groups. PE includes, for example, medium density polyethylene, high density polyethylene, low density polyethylene, ethylene alpha-olefin copolymers, ethylene vinyl acetate copolymers, ethylene acid copolymers, ethylene acrylate copolymers, cyclic olefin copolymers, or blends of such materials. Various PE's may be recycled as reclaimed PE.

As used throughout this application, the term “high density polyethylene” or “HDPE” refers to both (a) homopolymers of ethylene which have densities from about 0.960 g/cm³ to about 0.970 g/cm³ and (b) copolymers of ethylene and an alpha-olefin (usually 1-butene or 1-hexene) which have densities from about 0.940 g/cm³ to about 0.958 g/cm³. HDPE includes polymers made with Ziegler or Phillips type catalysts and polymers made with single-site metallocene catalysts. HDPE also includes high molecular weight “polyethylenes.”

As used throughout this application, the term “low density polyethylene” or “LDPE” refers to branched homopolymers having densities from about 0.915 g/cm³ to about 0.930 g/cm³, as well as copolymers containing polar groups resulting from copolymerization (such as with vinyl acetate or ethyl acrylate). LDPE may contain long branches off the main chain (often termed “backbone”) with alkyl substituents of two to eight carbon atoms.

As used throughout this application, the terms “copolymer of ethylene and at least one alpha-olefin” or “ethylene alpha-olefin copolymer” refer to a modified or unmodified copolymer produced by the co-polymerization of ethylene and any one or more alpha-olefins. Suitable alpha-olefins include, for example, C₃ to C₂₀ alpha-olef ins such as 1-propene, 1-butene, 1-pentene, 1-hexene, 1-octene, 1-decene, or blends of such materials. The co-polymerization of ethylene and an alpha-olefin may be produced by heterogeneous catalysis, such as co-polymerization reactions with Ziegler-Natta catalysis systems, including, for example, metal halides activated by an organometallic catalyst (e.g., titanium chloride) and optionally containing magnesium chloride complexed to trialkyl aluminum. Alternatively, the co-polymerization of ethylene and an alpha-olefin may be produced by homogeneous catalysis, such as co-polymerization reactions with metallocene catalysis systems which include constrained geometry catalysts, (e.g., monocyclopentadienyl transition-metal complexes). Homogeneous catalyzed copolymers of ethylene and alpha-olefin may include modified or unmodified ethylene alpha-olefin copolymers having a long-chain branched (i.e., 8-20 pendant carbons atoms) alpha-olefin co-monomer (commercially available as, for example, Affinity™ from The Dow Chemical Company (Midland, Mich.)), linear copolymers (commercially available as, for example, Tafmer™ from the Mitsui Petrochemical Corporation (Tokyo, Japan)), or modified or unmodified ethylene alpha-olefin copolymers having a short-chain branched (i.e., 3-6 pendant carbons atoms) alpha-olefin co-monomer (commercially available as, for example, Exact™ from ExxonMobil Chemical Company (Houston, Tex.)). Ethylene alpha-olefin copolymers may include, for example, linear low density polyethylene (LLDPE), metallocene-catalyzed LLDPE (mLLDPE), very low density polyethylene (VLDPE), metallocene-catalyzed VLDPE (mVLDPE), and ultra low density polyethylene (ULDPE). In some embodiments, linear low density polyethylene (including LLDPE and mLLDPE) may have a density of from about 0.910 g/cm³ to about 0.945 g/cm³. In some embodiments, very low density and ultra low density polyethylene (including VLDPE, mVLDPE, and ULDPE) may have a density of from about 0.87 g/cm³ to about 0.92 g/cm³.

As used throughout this application, the term “ethylene vinyl acetate” or “EVA” refers to copolymers comprised of repeating units of ethylene and vinyl acetate. Ethylene vinyl acetate copolymers may be represented by the general formula: [(CH₂—CH₂)ₙ—(CH₂—CH(COO)(CH₃)]ₙ. The vinyl acetate content may vary from less than about 10% to greater than about 95% by weight (of total EVA composition). The vinyl acetate content of EVA for packaging applications may vary from about 5% to about 40% by weight.

As used throughout this application, the term “ethylene acid copolymers” refers to copolymers comprised of repeating units of ethylene and acid groups. The acid group content may vary from about 2% to about 25% by weight. Non-limiting examples of ethylene acid copolymers include ethylene methacrylic acid (EMAA) and ethylene acrylic acid (EAA).

As used throughout this application, the term “ethylene acrylate copolymers” refers to copolymers comprised of repeating units of ethylene and acrylate groups. The acrylate group may be butyl-, ethyl-, methyl-, or otherwise. Non-limiting examples of ethylene acrylate copolymers include ethylene methyl acrylate (EMA) and ethylene methyl methacrylate (EMMA).

As used throughout this application the term “cyclic olefin copolymer” or ‘COG” refers to a class of polymeric materials based on cyclic olefin monomers and ethane, with one or more different cyclic olefin units randomly or alternately attached to an ethylene polymer backbone. Ethylene/norbornene copolymers are a non-limiting example of cyclic olefin copolymers.

As used throughout this application, the term “printing or ink”—in reference to the additional layers included in the first multilayer film, the second multilayer film or otherwise—refers to indicia added to a film. In some embodiments of the package described in the present application, a printing or ink layer may be added to the second multilayer film. Such layer may be reverse printed or surface printed on any layer of the second multilayer film, as known to a person of ordinary skill in the packaging arts.

The various embodiments of the first multilayer film and the second multilayer film of the package described in the present application may exhibit various properties, as exemplified and further described in the Examples below.

For example, a first multilayer film, such as first multilayer film 132 in FIG. 3 as described above or first multilayer film 232 in FIG. 5 as described above (e.g., comprising a first wall exterior layer comprising aluminum foil and a first wall interior layer comprising polyester), may have a puncture resistance of greater than about 10 Newtons and a tear resistance in each of the machine direction and transverse direction of greater than about 30 gram-force.

As a further example, a second multilayer film, such as second multilayer film 134 in FIG. 3 as described above or second multilayer film 234 in FIG. 5 as described above (e.g., comprising a second wall exterior layer comprising polyamide or polyester and a second wall interior layer comprising polyester), may have a puncture resistance of greater than about 30 Newtons and a tear resistance in each of the machine direction and transverse direction of greater than about 15 gram-force.

As used throughout this application, the term “puncture resistance” refers to the slow rate penetration (e.g., one inch per minute) resistance of a material to a driven probe (e.g., a one-eighth-inch-diameter hemispherical probe) at room temperature (23° C. (73° F.)). For the present application, puncture resistance was determined in accordance with ASTM F1306-90 (Reapproved 2008) (“Standard Test Method for Slow Rate Penetration Resistance of Flexible Barrier Films and Laminates”). ASTM F1306 provides methods for determining the force, energy, and elongation to perforation. For the present application, puncture is considered the force to perforation, i.e., the peak force to break. As such, puncture values are reported in Newtons.

As used throughout this application, the term “tear resistance” refers to the force to propagate tearing through a length of material after the tear has been initiated, using an Elmendorf-type (pendulum) tearing tester. For the present application, tear resistance was determined in accordance with ASTM D1922-09 (“Standard Test Method for Propagation Tear Resistance of Plastic Film and Thin Sheeting by Pendulum Method”). Tear resistance values are reported as tearing force, such as gram-force (gf). A high tear resistance value generally reflects a material that is more difficult to tear. Tear resistance may be determined for each of the machine direction and the transverse direction of a film. As used throughout this application, the term “machine direction” or “MD” refers to the direction of film transport during or after extrusion or film conversion. As used throughout this application, the term “transverse direction” or “TD” refers to the direction perpendicular to the machine direction.

Another property of the first multilayer film and the second multilayer film of the package described in the present application is the flex-crack resistance. As used throughout this application, the term “flex-crack resistance” or “flex-crack resistance (Gelbo)” refers to a material's resistance against repetitive strain. It is also referred to as flex durability or “Gelbo Flex.” For the present application, flex-crack resistance (Gelbo) was determined by attaching a sample of film to Gelbo flex-tester mandrels and subjecting the sample to a twisting motion combined with a horizontal motion (compression), thus repeatedly twisting and crushing the sample. For the present application, each sample was of similar size and was subjected to 45 cycles per minute for slightly longer than 11 minutes for a total of 500 flexes at a temperature of 23° C. (73° F.). The sample material was then examined for pinholes. A blue dye solution (Toluidine Blue) was used and allowed to stain through the pinholes onto an absorbent white backing to facilitate detection and counting of pinholes. Flex crack resistance (Gelbo) values are reported as the number of pinholes in the sample.

The first multilayer film, the second multilayer film, and the package described in the present application may be produced by various methods.

As a non-limiting example of a method of producing a first multilayer film, a first component of the first multilayer film may be produced by blown film coextrusion. This first component may then be laminated to a metal foil to form a first multilayer film. As another non-limiting example, a first component of a first multilayer film may be produced by laminating two acquired materials. This first component may then be laminated to a metal foil to form a first multilayer film. As a further non-limiting example, a first component of a first multilayer film may be acquired. This first component may then be laminated to a metal foil to form a first multilayer film. In some embodiments, the first component of a first multilayer film may be laminated to a metal foil by adhesive lamination, thermal lamination, or extrusion lamination; in some embodiments, such extrusion lamination is polyethylene extrusion lamination.

As a non-limiting example of a method of producing a second multilayer film, a first component of a second multilayer film may be produced by blown film coextrusion. This first component may then be laminated to another material (such as, as a non-limiting example, a polyester-comprising sealant) to form a second multilayer film. As another non-limiting example, a first component of a second multilayer film may be produced by laminating two acquired materials. This first component may then be laminated to another material (such as, as a non-limiting example, a polyester-comprising sealant) to form a second multilayer film. As a further non-limiting example, a first component of a second multilayer film may be acquired. This first component may then be laminated to another material (such as, as a non-limiting example, a polyester-comprising sealant) to form a second multilayer film. As a yet further non-limiting example, a second multilayer film may be produced entirely by blown film coextrusion or cast coextrusion.

The package described in the present application may be formed by sealing a first multilayer film to a second multilayer film. As described above, the first multilayer film forms a hermetic seal with the second multilayer film. Such hermetic seal may be formed by conventional heating means which generate sufficient heat on at least one of the first multilayer film or the second multilayer film for conduction to the other. Such heating may be performed by any one or more of a wide variety of methods, including but not limited to melt-bead sealing, thermal sealing, hot air sealing, hot wire sealing, infrared radiation, etc. A hermetic seal may also be formed by impulse sealing, ultrasonic sealing, pressure sealing, or other sealing methods known to a person of ordinary skill in the packaging arts.

The package described in the present application (such as, as non-limiting examples, package 10, package 110, or package 210) may be in any one of a variety of packaging configurations or forms (or packages) known to a person of ordinary skill in the packaging arts. Possible packaging configurations include but are not limited to horizontal-form-fill-seal package, vertical form-fill-seal package, quad-seal package, three-side-seal package, four-side-seal package, quad-pack, bag, pouch, stand-up pouch, K-seal pouch, doyen-style pouch, side-gusset pouch, pillow pouch, forming/non-forming package, thermoformed tray with lid, or other packaging configurations known to a person of ordinary skill in the packaging arts. Any such packaging configuration may include a first multilayer film, a second multilayer film, or both a first multilayer film and a second multilayer film that includes peelable functionality, as known to a person of ordinary skill in the art, such that package 10, package 110, package 210, or other package may be easy to open for an end-user consumer.

In some embodiments, a package (such as, as a non-limiting example, package 210) may be a pouch, in any of the various forms of a pouch described above (such as, as non-limiting examples, stand-up pouch, K-seal pouch, doyen-style pouch, side-gusset pouch, or pillow pouch).

In other embodiments, a package (such as, as a non-limiting example, package 210) may a forming/non-forming package. In such embodiments, a first multilayer film is the non-forming film and a second multilayer film is the forming film. In such embodiments, a second multilayer film may form a “pocket” is which to place a food item (such as food item 250) to be cooked, as appropriate, by the heat source of a grilling apparatus. Also, in such forming/non-forming embodiments, a second multilayer film may have a non-limiting thickness of from about 127 micron (5 mil) to about 508 micron (20 mil). In other embodiments of a package that are not forming/non-forming embodiments, a second multilayer film may have a non-limiting thickness of from about 38 micron (1.5 mil) to about 254 micron (10 mil).

In some embodiments, a package may be configured to comprise recyclable materials. As used throughout this application, the term “recyclable” refers the ability to be converted into a new useful item, by means of reprocessing in a polyethylene, polyester, metal foil, or other waste stream. As a non-limiting example, in some embodiments, the first wall exterior layer may be bonded to the first wall interior layer in such a manner as to allow the metal foil to be easily separated from the other materials (such as, as a non-limiting example, a polyester sealant) for recycling of metal foil in one waste stream and materials included in the first wall interior layer, as described above, in another (or other) waste stream(s). Easy separation may be facilitated by a low bond strength between the first wall exterior layer and the first wall interior layer or by registered lamination between the first wall exterior layer and the first wall interior layer or by other means known to a person of ordinary skill in the art.

### EXAMPLES

To further exemplify the various embodiments of the present application, several example and comparative example first walls (FW) and example and comparative example second walls (SW) were produced (or acquired) and evaluated for various properties. TABLE 1 provides information regarding the composition of example and comparative example first walls, and TABLE 2 provides information regarding the composition of example and comparative example second walls. In addition to the materials listed in TABLE 1 and TABLE 2, various layers included various processing aids known to a person of ordinary skill in the packaging arts.

TABLE 1

| | Thickness | Layer 1 | | | | | | | | |
|---|---|---|---|---|---|---|---|---|---|---|
| | micron (mil) | (exterior layer) | Layer 2 | Layer 3 | Layer 4 | Layer 5 | Layer 6 | Layer 7 | Layer 8 | Layer 9 |
| FW Example 1 | 98 (3.85) | 9 micron (0.35 mil) | PE extrusion | ULDPE + | tie | nylon 6 + | EVOH | nylon 6 + | tie | PET |
| | | aluminum foil | lamination | LLDPE | | nylon 6I/6T | | nylon 6I/6T | | |
| FW Example 2 | 47 (1.85) | 9 micron (0.35 mil) | PE extrusion | OPET | | | | | | |
| | | aluminum foil | lamination | | | | | | | |
| FW Example 3 | 102 (4) | 9 micron (0.35 mil) | PE extrusion | ULDPE + | tie | nylon 6 + | EVOH | nylon 6 + | tie | PET |
| | | aluminum foil | lamination | LLDPE | | nylon 6I/6T | | nylon 6I/6T | | |
| FW Example 4 | 51 (2) | 9 micron (0.35 mil) | PE extrusion | OPET | | | | | | |
| | | aluminum foil | lamination | | | | | | | |
| FW Example 5 | varies | 9 micron (0.35 mil) | lamination | PE | tie | PA | tie | PET | tie | PET |
| | | aluminum foil | | | | | | | | |
| FW Example 6 | varies | 9 micron (0.35 mil) | lamination | BON | adhesive | OPET | | | | |
| | | aluminum foil | | | lamination | | | | | |
| FW Comparative | 25 (1) | 25 micron (1 mil) | | | | | | | | |
| Example 1 | | aluminum foil | | | | | | | | |

TABLE 2

| | Thickness | Layer 1 | | | | | | | | |
|---|---|---|---|---|---|---|---|---|---|---|
| | micron (mil) | (exterior layer) | Layer 2 | Layer 3 | Layer 4 | Layer 5 | Layer 6 | Layer 7 | Layer 8 | Layer 9 |
| SW Example 1 | 89 (3.5) | nylon 6/6 + | tie | nylon 6 | EVOH | nylon 6 | tie | ULDPE + | adhesive | 25 micron |
| | | nylon 6 | | | | | | LLDPE | lamination | (1 mil) |
| | | | | | | | | | | OPET |
| SW Example 2 | 76 (3) | nylon 6/6 + | tie | nylon 6 | EVOH | nylon 6 | tie | ULDPE + | adhesive | 25 micron |
| | | nylon 6 | | | | | | LLDPE | lamination | (1 mil) |
| | | | | | | | | | | OPET |
| SW Example 3 | 41 (1.6) | BON | adhesive | 25 micron | | | | | | |
| | | | lamination | (1 mil) OPET | | | | | | |
| SW Example 4 | 91 (0.36) | BON | adhesive | 76 micron | | | | | | |
| | | | lamination | (3 mil) PETG | | | | | | |
| SW Example 5 | 203 (8) | nylon 6/6 + | tie | nylon 6 | EVOH | nylon 6 | tie | ULDPE + | adhesive | 127 micron |
| | | nylon 6 | | | | | | LLDPE | lamination | (5 mil) |
| | | | | | | | | | | APET |
| SW Example 6 | 279 (11) | nylon 6/6 + | tie | nylon 6 | EVOH | nylon 6 | tie | ULDPE + | adhesive | 203 micron |
| | | nylon 6 | | | | | | LLDPE | lamination | (8 mil) |
| | | | | | | | | | | APET |
| SW Example 7 | 279 (11) | nylon 6/6 + | tie | nylon 6 | EVOH | nylon 6 | tie | ULDPE + | adhesive | 178 micron |
| | | nylon 6 | | | | | | LLDPE | lamination | (7 mil) |
| | | | | | | | | | | APET |
| SW Example 8 | 152 (6) | nylon 6/6 + | tie | nylon 6 | tie | nylon 6 | tie | ULDPE + | adhesive | 76 micron |
| | | nylon 6 | | | | | | LLDPE | lamination | (3 mil) |
| | | | | | | | | | | APET |
| SW Example 9 | 203 (8) | nylon 6/6 + | tie | nylon 6 | EVOH | nylon 6 | tie | ULDPE + | adhesive | 76 micron |
| | | nylon 6 | | | | | | LLDPE | lamination | (3 mil) |
| | | | | | | | | | | PETG |
| SW Example | 279 (11) | nylon 6/6 + | tie | nylon 6 | EVOH | nylon 6 | tie | ULDPE + | adhesive | 76 micron |
| 10 | | nylon 6 | | | | | | LLDPE | lamination | (3 mil) |
| | | | | | | | | | | PETG |
| SW Example | 24 (0.96) | OPET | adhesive | 12 micron | | | | | | |
| 11 | | | lamination | (0.48 mil) OPET | | | | | | |
| SW Example | varies | PA | tie | PA | tie | PA | tie | PE | adhesive | OPET |
| 12 | | | | | | | | | lamination | |
| SW | 19 (0.76) | 19 micron | | | | | | | | |
| Comparative | | (0.76 mil) | | | | | | | | |
| Example 1 | | OPET | | | | | | | | |

Each of FW Example 1 and FW Example 3 was formed by blown coextrusion of a film comprising Layers 3-9 and then laminating such blown coextruded film to an obtained aluminum foil film by the method described in TABLE 1. FW Example 5 is a prophetic example and would be similarly formed. Each of FW Example 2 and FW Example 4 was formed by obtaining an OPET film and then laminating such OPET film to an obtained aluminum foil film by the method described in TABLE 1. FW Example 6 is a prophetic example and would be formed by adhesively laminating an obtained OPET film to an obtained BON film and then laminating such adhesive lamination to an aluminum foil film by the method described in TABLE 1. (The reference to “lamination” for FW Examples 5 and 6 includes extrusion lamination (with any appropriate extrudate as known to a person of ordinary skill in the packaging arts, including but not limited to polyethylene, including but not limited to blends of polyethylene (such as PE and EAA)) or adhesive lamination (with any appropriate adhesive as known to a person of ordinary skill in the packaging arts).) FW Comparative Example 1 was an obtained monolayer 25-micron (1-mil) aluminum foil film.

Each of SW Examples 1-2 and 5-10 was formed by blown coextrusion of a film comprising Layers 1-7 and then adhesive laminating such blown coextruded film to the obtained Layer 9 film, as described in TABLE 2. SW Example 12 is a prophetic example and would be similarly formed. Each of SW Examples 3, 4, and 11 was formed by adhesively laminating an obtained Layer 1 film and an obtained Layer 3 film, as each is described in TABLE 2. SW Comparative Example 2 was an obtained monolayer 19-micron (0.76-mil) OPET film.

FW Examples 1 and 2, FW Comparative Example 1, SW Examples 1, 3, and 5 and SW Comparative Example 1 were evaluated for puncture resistance, tear resistance, and flex-crack resistance (Gelbo). TABLE 3 reports the results.

TABLE 3

| | | | | Flex-crack resistance |
|---|---|---|---|---|
| | Puncture | Tear resistance | | (Gelbo) |
| | resistance | (gf) | | at 23° C. |
| | (Newtons) | MD | TD | (number of pinholes) |
| FW Example 1 | 24.8 | 394 | 1554 | 6 |
| | | 3200-gram | | |
| | | pendulum | | |
| FW Example 2 | 32.0 | 37.9 | 42.4 | 68 |
| | | 200-gram | | |
| | | pendulum | | |
| FW Comparative | 7.25 | 22.3 | 26.7 | failed* |
| Example 1 | | 200-gram | | |
| | | pendulum | | |
| SW Example 1 | 38.8 | 124 | 146 | 2 |
| | | 200-gram | 1600-gram | |
| | | pendulum | pendulum | |
| SW Example 3 | 50.6 | 26.9 | 28.2 | 0 |
| | | 200-gram | | |
| | | pendulum | | |
| SW Example 5 | 68.7 | 782 | 929 | 5** |
| | | 3200-gram | | |
| | | pendulum | | |
| SW Comparative | 26.5 | 10.7 | 13.1 | 23 |

| | |
|---|---|
| Example 1 | 200-gram |
| | pendulum |

(Notes: Flex-crack resistance (Gelbo) for FW Comparative Example 1 is described as “failed*” in that FW Comparative Example 1 completely failed at only three flexes and the sample was not subject to the 500 flexes. Flex-crack resistance (Gelbo) for SW Example 5 is described as “5**” to indicate the number of holes that penetrated the entire film; SW Example 5 had other holes penetrating through only one ply, and the dye seeped between the layers.)

As reported in TABLE 3, FW Examples 1 and 2 (in other words, various embodiments of the first multilayer film comprising the first wall of the package described in the present application) demonstrated a significant improvement in mechanical toughness and abuse resistance, as compared to a film comprising a single layer of aluminum foil.

As further reported in TABLE 3, SW Examples 1, 3, and 5 (in other words, various embodiments of the second multilayer film comprising the second wall of the package described in the present application) demonstrated a significant improvement in mechanical toughness and abuse resistance, as compared to a film comprising a single layer of OPET.

Each and every document cited in this present application, including any cross-referenced or related patent or application, is incorporated in this present application in its entirety by this reference, unless expressly excluded or otherwise limited. The citation of any document is not an admission that it is prior art with respect to any embodiment disclosed or claimed in this present application or that it alone, or in any combination with any other reference or references, teaches, suggests, or discloses any such embodiment. Further, to the extent that any meaning or definition of a term in this present application conflicts with any meaning or definition of the same term in a document incorporated by reference, the meaning or definition assigned to that term in this present application (including the appended claims) governs.

Unless otherwise indicated, all numbers expressing sizes, amounts, ranges, limits, and physical or other properties used in the present application (including the appended claims) are to be understood as being preceded in all instances by the term “about.” Accordingly, unless expressly indicated to the contrary, the numerical parameters set forth in the present application (including the appended claims) are approximations that can vary depending on the desired properties sought to be obtained by a person of ordinary skill in the packaging arts without undue experimentation using the teachings disclosed in the present application.

As used in the present application (including the appended claims), the singular forms “a,” “an,” and “the” encompass embodiments having plural referents, unless the context clearly dictates otherwise. As used in the present application (including the appended claims), the term “or” is generally employed in its sense including “and/or,” unless the context clearly dictates otherwise.

Spatially related terms, including but not limited to, “lower,” “upper,” “beneath,” “below,” “above,” “bottom,” and “top,” if used in the present application (including the appending claims), are used for ease of description to describe spatial relationships of element(s) to another. Such spatially related terms encompass different orientations of the package in use or operation, in addition to the particular orientations depicted in the drawings and described in the present application (including the appended claims). For example, if an object depicted in the drawings is turned over or flipped over or inverted, elements previously described as below or beneath other elements would then be above those other elements.

The description, examples, embodiments, and drawings disclosed are illustrative only and should not be interpreted as limiting. The present invention includes the description, examples, embodiments, and drawings disclosed; but it is not limited to such description, examples, embodiments, or drawings. The reader should assume that features of one disclosed embodiment can also be applied to all other disclosed embodiments, unless expressly indicated to the contrary. Modifications and other embodiments will be apparent to a person of ordinary skill in the packaging arts, and all such modifications and other embodiments are intended and deemed to be within the scope of the present invention as described in the claims.

What is claimed is as follows:

1. A package comprising
(a) a first wall comprising a first multilayer film comprising a first wall exterior layer comprising metal foil and a first wall interior layer, wherein the first multilayer film is configured to be placed adjacent the heat source of a grilling apparatus and is thermally stable after exposure to temperatures greater than about 220° C. (425° F.), and
(b) a second wall opposing the first wall, wherein the second wall comprises a second multilayer film comprising a second wall exterior layer and a second wall interior layer, wherein the second multilayer film is configured to be placed opposite the heat source of a grilling apparatus and is thermally stable after exposure to temperatures up to about 220° C. (425° F.),
wherein the first multilayer film is configured to form a hermetic seal with the second multilayer film.

2. The package of claim 1 wherein the first wall exterior layer has a thickness of less than about 25 micron (1 mil).

3. The package of claim 1 wherein the first wall exterior layer has a thickness of from about 6 micron (0.23 mil) to about 24 micron (0.94 mil).

4. The package of claim 1 wherein the metal foil comprises aluminum foil.

5. The package of claim 1 wherein the first multilayer film is thermally stable after exposure to temperatures from greater than about 220° C. (425° F.) to about 480° C. (900° F.).

6. The package of claim 1 wherein the first multilayer film comprises a layer comprising polyamide, a layer comprising polyester, or a layer comprising polyamide and a layer comprising polyester; the second multilayer film comprises a layer comprising polyamide, a layer comprising polyester, or a layer comprising polyamide and a layer comprising polyester; or each of the first multilayer film and the second multilayer film comprises a layer comprising polyamide, a layer comprising polyester, or a layer comprising polyamide and a layer comprising polyester.

7. The package of claim 1 wherein the first wall interior layer is a first wall sealant layer comprising polyester, wherein the second wall interior layer is a second wall sealant layer comprising polyester, or wherein the first wall interior layer is a first wall sealant layer comprising polyester and the second wall interior layer is a second wall sealant layer comprising polyester.

8. The package of claim 1 wherein the second multilayer film comprises a second wall exterior layer comprising polyamide or polyester.

9. The package of claim 1 wherein the second multilayer film comprises a transparent portion.

10. The package of claim 1 wherein the first multilayer film has a puncture resistance in accordance with ASTM F1306 of greater than about 10 Newtons and a tear resistance in accordance with D1922 in each of the machine direction and transverse direction of greater than about 30 gram-force.

11. The package of claim 1 wherein the second multilayer film has a puncture resistance in accordance with ASTM F1306 of greater than about 30 Newtons and a tear resistance in accordance with D1922 in each of the machine direction and transverse direction of greater than about 15 gram-force.

12. A package comprising
(a) a first wall comprising a first multilayer film comprising a first wall exterior layer comprising aluminum foil and a first wall interior layer comprising polyester, wherein the first multilayer film is thermally stable after exposure to temperatures greater than about 220° C. (425° F.) and wherein the first wall exterior layer has a thickness of less than about 25 micron (1 mil), and
(b) a second wall opposing the first wall, wherein the second wall comprises a second multilayer film comprising a second wall exterior layer comprising polyamide or polyester and a second wall interior layer comprising polyester, wherein the second multilayer film is thermally stable after exposure to temperatures up to about 220° C. (425° F.),
wherein the first wall interior layer is configured to form a hermetic seal with the second wall interior layer.

13. The package of claim 12 wherein the first multilayer film is configured to be placed adjacent the heat source of a grilling apparatus and the second multilayer film is configured to be placed opposite the heat source of a grilling apparatus.

14. The package of claim 12 wherein the first wall exterior layer has a thickness of from about 6 micron (0.23 mil) to about 24 micron (0.94 mil).

15. The package of claim 12 wherein the first multilayer film is thermally stable after exposure to temperatures from greater than about 220° C. (425° F.) to about 480° C. (900° F.).

16. The package of claim 12 wherein the second multilayer film comprises a transparent portion.

17. A package comprising
(a) a first wall comprising a first multilayer film comprising a first wall exterior layer comprising aluminum foil and a first wall interior layer comprising polyester, wherein the first multilayer film is thermally stable after exposure to temperatures from greater than about 220° C. (425° F.) to about 480° C. (900° F.) and wherein the first wall exterior layer has a thickness of from about 6 micron (0.23 mil) to about 24 micron (0.94 mil),
(b) a second wall opposing the first wall, wherein the second wall comprises a second multilayer film comprising a second wall exterior layer comprising polyamide or polyester and a second wall interior layer comprising polyester, wherein the second multilayer film is thermally stable after exposure to temperatures up to about 220° C. (425° F.) and wherein the second multilayer film comprises a transparent portion,
(c) a food item, and
(d) a hermetic seal sealing the first wall interior layer to the second wall interior layer.

18. The package of claim 17 wherein the first multilayer film is configured to be placed adjacent the heat source of a grilling apparatus and the second multilayer film is configured to be placed opposite the heat source of a grilling apparatus.

19. The package of claim 17 wherein a portion of the hermetic seal sealing the first wall interior layer to the second wall interior layer is configured to vent when the package is exposed to a heat source.

20. The package of claim 17 wherein (a) the package is a pouch or (b) the package is a forming/non-forming package wherein the first multilayer film is a non-forming film and the second multilayer film is a forming film.
